(19) United States
(12) Patent Application Publication
(10) Pub. No.: US 2024/0135417 A1
(43) Pub. Date: Apr. 25, 2024

(54) METHOD AND DEVICE FOR DETERMINING AND OUTPUTTING JOURNEY COSTS OF A VEHICLE

(71) Applicant: MERCEDES-BENZ GROUP AG, Stuttgart (DE)

(72) Inventor: Christian BOOTZ, Böblingen (DE)

(21) Appl. No.: 18/275,252

(22) PCT Filed: Jan. 21, 2022
(86) PCT No.: PCT/EP2022/051360

§ 371 Date: Jul. 31, 2023

(30) Foreign Application Priority Data
Feb. 2, 2021 (DE) 10 2021 000 523.6

(51) Int. Cl. G06Q 30/0283

(52) U.S. Cl. CPC G06Q 30/0283

(57) ABSTRACT

A method for determining and outputting journey costs of a vehicle involves automatically determining the journey costs taking into account costs for a plurality of operating means, maintenance operating costs, and costs for parameters that can be influenced by a vehicle user.

### BACKGROUND AND SUMMARY OF THE INVENTION

Exemplary embodiments of the invention relate to a method for determining and outputting journey costs of a vehicle, wherein the determined journey costs are output to a vehicle user, as well as to a device for carrying out the method.

DE 10 2018 001 234 A1 discloses a method for determining and outputting vehicle costs of a vehicle. The journey costs are determined using a fuel consumption of the vehicle and using fuel costs, and the journey costs are output to a vehicle user. When determining the fuel consumption, a traffic flow, a driving behavior of a driver of the vehicle and route information relating to a route driven are taken into account. When determining the fuel costs, a refueling behavior is determined accounting for a time of day, a current fuel price and a petrol station preferred by the driver.

Exemplary embodiments of the invention are directed to a developed and optimized method and a device for determining and outputting journey costs of a vehicle.

A method according to the invention for determining and outputting journey costs of a vehicle, wherein the determined journey costs are output to a vehicle user, provides for the journey costs being automatically determined taking into account costs for a plurality of operating means, maintenance operating costs, and costs for parameters that can be influenced by a vehicle user.

In the method, costs accrued in the driving operation of the vehicle are also taken into account for alternative drives and for automated driving functions and driver assistance functions, wherein a drive type can be abstracted.

The determined journey costs are comparatively transparent as total costs such that it is possible to compare the determined costs, for example, with costs of alternative transport means, in particular with costs of public transport.

The journey costs also reflect transport costs, such that they can be identified and/or taken into account in a profit and loss calculation.

By this use, a cost summary can be transparently represented such that optimization potentials can be identified if applicable.

By means of the method, a transparency for journey and/or transport costs can additionally be created for an automated driving operation of the vehicle so that functional models of virtual vehicle users with regard to an energy efficiency can be compared. It would thus be conceivable for the future that virtual vehicle users are implemented in a central computer unit and can be booked as drivers for automated vehicles. Journey costs can thus be compared when using different driver models. On this basis, it is made possible to make different driver models with different driver costs available for automated journeys.

In an embodiment of the method, when determining the costs for a plurality of operating means, recorded consumption of petrol, diesel, carbamide, gas, electrical energy, and/or hydrogen is/or are taken into account, whereby it is possible to determine and correspondingly output substantially real journey costs for a vehicle operated exclusively with an internal combustion engine, for a hybrid vehicle, and for a vehicle operated exclusively by an electric engine.

In a development of the method, the costs for a plurality of operating means are determined in an automated manner, and taken into account when determining the journey costs. The costs for a plurality of operating means are recorded depending on consumption, wherein the consumption is in turn dependent on further parameters, for example on a traffic flow, a journey route, and on a time of day.

A development of the method provides that when determining the maintenance costs, tire wear, brake wear, and/or costs for an oil change is or are taken into account. A respective wear can be based on prognostics that are used as the basis for determining the maintenance operating costs.

The tire wear, the brake wear, and/or a required oil change is/are determined using maintenance data of a maintenance system and/or using maintenance inputs, for example on the basis of maintenance intervals stored in the vehicle. In particular, for this purpose there is provision for a vehicle user storing costs for a maintenance carried out on the vehicle, for example, so that the costs can be factored in proportionately when determining the maintenance costs.

In a possible embodiment, the method further provides for a driving behavior and a refueling behavior and/or charging behavior being taken into account in the determination. If, for example, the vehicle user is driving the vehicle in a comparatively sporty manner, the vehicle's consumption of fuel or electrical energy can be higher than in other modes of driving, for example in the comfort mode of the vehicle.

In a possible development of the method, it is additionally possible to ensure that the journey costs and/or partial costs are output sequentially or when requested, so that an overview both with regard to the partial costs, i.e., the costs of the operating means, the maintenance operating costs, and the costs in connection with parameters that can be influenced by a vehicle user, and the total costs, for example in relation to the last journey undertaken by the vehicle, can be output, in particular displayed to the vehicle user.

The consumption of electrical energy is further determined on the basis of a standardized energy value, e.g., in kilowatt hours, wherein in a further possible embodiment, the standardized energy value is determined with reference to a regionally usual market price for electrical energy. In particular, a standardized energy value that is close to reality is used to determine the consumption of the electrical energy.

With regard to determining the journey costs of the vehicle, a further embodiment of the method makes provision for accrued maintenance operating costs being input by a vehicle user, such that these costs can be at least proportionately taken into account when determining the journey costs of the vehicle.

The invention additionally relates to a device for carrying out a method for determining and outputting journey costs of a vehicle. According to the invention, the device comprises a first superordinate data processing unit designed to determine accrued costs for a plurality of operating means for an internal combustion engine and an electrical drive unit. A second superordinate data processing unit is designed to determine maintenance operating costs and a third superordinate data processing unit is designed to determine costs for parameters that can be influenced by a vehicle user. The device additionally comprises a total data processing unit designed to determine the journey costs of the vehicle using the costs for a plurality of operating means, the maintenance operating costs, and the costs for the parameters that can be influenced by the vehicle user, and an output unit for outputting at least the determined journey costs.

By means of the device, it is possible to determine the individual costs and, using these costs, to determine the journey costs as total costs and, for example, to output said total costs to a vehicle user in order, among other things, to identify any potential savings with regard to a driving operation of the vehicle.

Exemplary embodiments of the invention are explained in more detail in the following with reference to the drawings.

### BRIEF DESCRIPTION OF THE DRAWING FIGURES

In the figures:

FIG. 1 schematically shows a partial device for determining costs for operating means of a vehicle,

FIG. 2 schematically shows a partial device for determining maintenance operating costs,

FIG. 3 schematically shows a partial device for determining costs for parameters that can be influenced by a vehicle user,

FIG. 4 schematically shows a device for further processing data with regard to determining vehicle costs and the determined vehicle costs, and

FIG. 5 schematically shows a data processing unit and details of a data history.

Parts corresponding to one another are provided with the same reference numerals in all figures.

### DETAILED DESCRIPTION

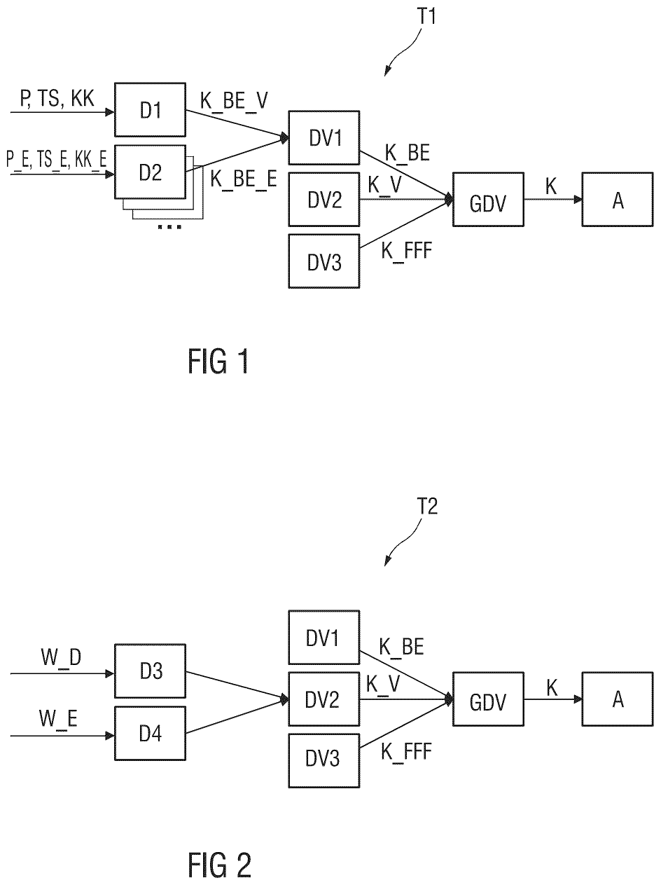

FIG. 1 shows a partial device T1 of a device 1 for determining costs K_BE for a plurality of operating means of a vehicle comprising an internal combustion engine and an electrical drive unit for its driving operation. The partial device T1 is a component of the device 1 for determining journey costs K and/or transport costs of a vehicle.

In particular via a so-called “shared mobility”, it is more and more frequently required and of increasing importance to determine actual journey costs and/or transport costs.

A method described in the following makes provision for taking into account costs K_BE for a plurality of operating means, maintenance operating costs K_V and costs K_FFF for parameters that can be influenced by a vehicle user when determining the journey costs K for a vehicle shown in FIG. 4.

FIG. 1 shows the determination of the costs K_BE for a plurality of operating means using the partial device T1. The individual operating means are determined. In particular, fuel, i.e., petrol or diesel, carbamide, gas, electrical energy, and/or hydrogen as operating means and the consumption thereof are determined in an automated manner, depending on the vehicle type.

A first data processing unit D1 is provided for determining costs K_BE_V for a consumption of operating means of an internal combustion engine, while a second data processing unit D2 is provided to determine costs K_BE_E for a consumption of operating means of an electrical drive unit.

Fuel costs KK, a fuel price P, and a preferred petrol station TS are taken into account as input values of the first data processing unit D1 to determine the costs K_BE_V for operating means of the internal combustion engine.

The second data processing unit D2 takes into account a price P_E for electrical energy, a petrol station TS_E, and costs KK_E for the electrical energy as input values when determining the costs K_BE_E of the operating means of the electrical drive unit.

The determined costs K_BE_V for the consumption of the operating means of the internal combustion engine and the determined costs K_BE_E for the consumption of the electric drive unit are fed to a first superordinate data processing unit DV1.

The first superordinate data processing unit DV1 calculates the costs K_BE for the operating means on the basis of a standardized energy value (kWh) of a data processing unit D1, D2 or of the two data processing units D1, D2, which respectively determine the costs K_BE_V, K_BE_E for a drive unit, i.e., for the internal combustion engine and for the electric drive unit, and can simultaneously be operated.

If the vehicle is a hybrid vehicle, then the hybrid vehicle has an internal combustion engine and an electric drive unit, wherein the costs K_BE_V for the electric drive unit can be negative, in particular due to recuperation.

If a data processing unit D1, D2 is installed in the vehicle which represents a drive mode that is not present in the vehicle, this data processing unit D1, D2 outputs neutral costs of “zero”. The same device 1 can thus be installed in all vehicles having different drive modes to determine the journey costs K.

A fuel consumption KV shown in FIG. 4 then becomes an energy consumption EV, whereby a third superordinate data processing unit DV3 is independent of drive.

A calculation in the first data processing unit D1 and the second data processing unit D2 takes place as is known from the prior art, wherein when refueling or charging, a fuel price P and/or a price P_E for electrical energy is/are obtained by means of a vehicle-to-infrastructure communication from the petrol station TS or on the basis of a current position from a central computer unit RE shown in FIG. 4.

The total costs K_BE for the consumed operating means, determined by means of the first superordinate data processing unit DV1, are fed to a total data processing unit GDV of the device 1, wherein the maintenance operating costs K_V from a second superordinate data processing unit DV2 and the costs K_FFF for the parameters that can be influenced by the vehicle user from a third superordinate data processing unit DV3 are additionally fed to the device to determine the journey costs K of the vehicle.

The determined journey costs K are then fed to an output unit A to output the journey costs K. By means of the output unit A, determined partial costs and/or the determined journey costs K can be output sequentially or when requested.

FIG. 2 shows a partial device T2 of the device 1 for determining the maintenance operating costs K_V of the vehicle.

A maintenance system D3 of the vehicle, to which maintenance data W_D is fed, and an interface D4 for inputting maintenance data W_E are depicted, the respective determined costs of which are fed to a second superordinate data processing unit DV2 to determine the maintenance operating costs K_V. These maintenance operating costs K_V determined by means of the second superordinate data processing unit DV2, in particular wear costs, are then fed to the total data processing unit GDV to determine the journey costs K.

By means of the maintenance system D3, maintenance intervals for the respective drive unit, for a transmission, for vehicle axles etc. are determined taking into account an actual use of the vehicle.

The second superordinate data processing unit DV2 relates wear data of the vehicle to the individual maintenance intervals and to maintenance carried out by the maintenance system D3, which is designed to make this maintenance data available to other systems in the vehicle.

Via this interface D4, a vehicle user or another authorized person has the option of inputting, in particular storing, maintenance costs for maintenance actually carried out.

The input maintenance costs can then be retroactively attributed to historical data so that a history is coherent and updated maintenance operating costs K_V are fed to other systems, or, however, the maintenance operating costs K_V can be called up. In other words, the input maintenance costs are in future included in relation to a wear of a corresponding vehicle component and considered to be accrued costs. If, for example, an oil change is required once per 100,000 kilometers travelled at a particular cost, then correspondingly proportional costs equivalent to the costs for the oil change divided by 100,000 are included for every kilometer driven.

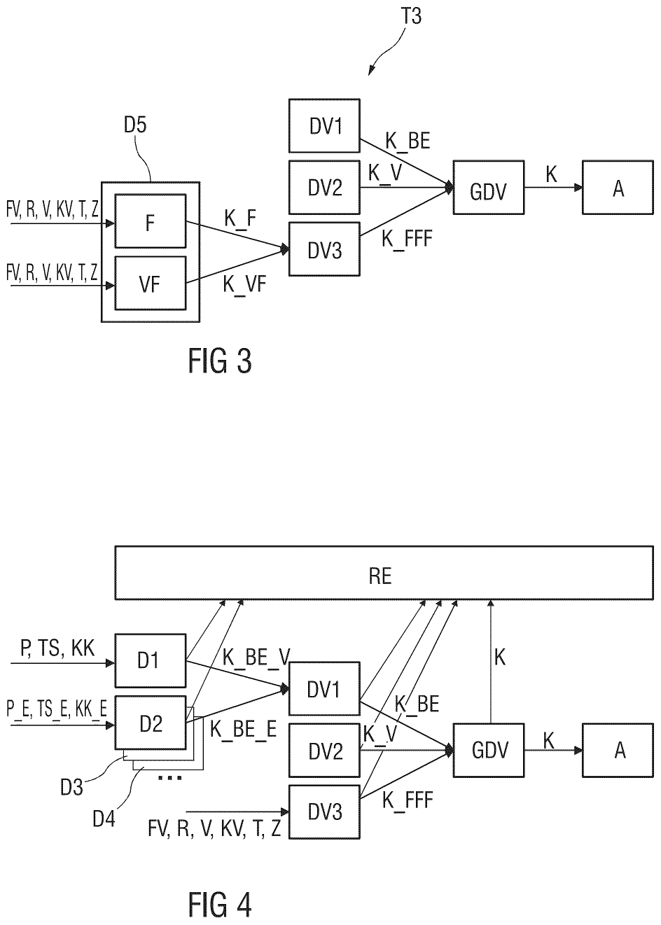

FIG. 3 shows a partial device T3 of the device 1 for determining and outputting the journey costs K, wherein a third data processing unit D5 takes a virtual driver VF into account in addition to an actual vehicle user, i.e., a driver F of the vehicle.

When costs K_F of the actual driver F and costs K_VF of the virtual driver VF are determined, a driving behavior FV, route information R, a traffic flow V, a fuel consumption KV, a refueling behavior T, and a time of day Z can be taken into account in relation to the driving operation of the vehicle and a refueling/charging of the vehicle.

The determined costs K_F of the actual driver F and the costs K_VF of the virtual driver VF are fed to the third superordinate data processing unit DV3, which then feeds the costs K_FFF for parameters that can be influenced by a vehicle user, i.e., costs for a driver driving function, to the total data processing unit GDV to determine the journey costs K. It is thus possible via the construct of a virtual driver to differentiate between costs arising on a stretch of road covered by an actual driver or on stretches of road covered autonomously (without a driver).

In FIG. 4, the first partial device T1 according to FIG. 1 is depicted, wherein all the values fed to the respective superordinate data processing units DV1, DV2, DV3 are shown.

The costs K_BE_V, K_BE_E, K_F, K_VF determined by the data processing units D1, D2, D5, as well as the costs K_BE, K_V, K_FFF determined by the superordinate data processing units DV1, DV2, DV3 and the journey costs K determined by the total data processing unit GDV, can be fed to other systems for further processing as intermediate data and/or partial costs, in particular to the central computer unit RE, so that this data can be further processed as fleet data.

As an alternative or in addition, this data can be used and stored as historical data in order to recognize changes, e.g., an optimized driving behavior FV of the driver F or an increased fuel consumption KV of the internal combustion engine.

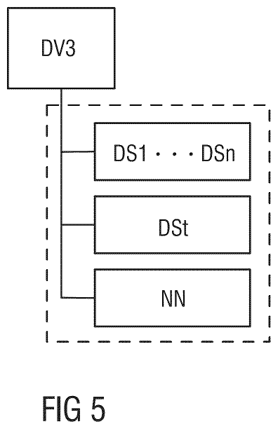

In FIG. 5, the third superordinate data processing unit DV3 is depicted with details of a data history in an exemplary form.

By breaking down a cost calculation described in FIGS. 1 to 3 to determine the journey costs K, a breakdown of historical data analogously results.

Using data sets DS1 to DSn, data statistics DSt and neural networks NN, the possibility arises of including historical data in a calculation, for example of a refueling behavior.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method, comprising:
automatically determining journey costs of a vehicle by accounting for costs for a plurality of operating means, maintenance operating costs, and costs for parameters that can be influenced by a vehicle user; and
outputting the automatically determined journey costs to a vehicle user.

12. The method of claim 11, wherein recorded consumption of petrol, diesel, carbamide, gas, electrical energy, or hydrogen is accounted in the determination of the costs for the plurality of operating means.

13. The method of claim 11, wherein the costs for the plurality of operating means are determined in an automated manner.

14. The method of claim 11, wherein tire wear, brake wear, or costs for an oil change is accounted for in the determination of the maintenance operating costs.

15. The method of claim 14, wherein the tire wear, the brake wear, or the required oil change is determined using maintenance data of a maintenance system or is determined using maintenance inputs.

16. The method of claim 11, wherein a driving behavior of a vehicle user and a refueling behavior or a charging behavior is accounted for in the determination of the journey costs.

17. The method of claim 11, wherein the journey costs or partial costs are output sequentially or are output when requested.

18. The method of claim 12, wherein the consumption of electrical energy is determined based on a standardized energy value.

19. The method of claim 11, further comprising:
receiving, from the vehicle user, inputted accrued maintenance operating costs.

20. A device for determining and outputting journey costs of a vehicle a vehicle, the device comprising:
a first superordinate data processing unit configured to determine accrued costs for a plurality of operating means for an internal combustion engine and an electrical drive unit;
a second superordinate data processing unit configured to determine maintenance operating costs;
third superordinate data processing unit configured to determine costs for parameters that can be influenced by a user of the vehicle;
a total data processing unit configured to determine the journey costs of the vehicle using the costs for a plurality of operating means, the maintenance operating costs, and the costs for the parameters that can be influenced by the vehicle user; and
an output unit configured to output at least the determined journey costs.
